(19) United States
(12) Patent Application Publication
(10) Pub. No.: US 2025/0282188 A1
(43) Pub. Date: Sep. 11, 2025

(54) ANTI-SKID DEVICE

(71) Applicant: AFFIN AS, NOTODDEN (NO)

(72) Inventors: Emil ABRY, HOSLE (NO); Christopher Jhon KAVANAGH, OSLO (NO); Christian ABRY, EIKSMARKA (NO); Harald FURU, OSLO (NO)

(21) Appl. No.: 18/863,682

(22) PCT Filed: Apr. 24, 2023
(86) PCT No.: PCT/NO2023/050090

§ 371 Date: Nov. 7, 2024

(30) Foreign Application Priority Data
May 8, 2022 (NO) 20220526

(51) Int. Cl. B60C 27/02

(52) U.S. Cl. CPC B60C 27/0269; B60C 27/023; B60C 27/0238

(57) ABSTRACT

This present invention relates to an anti-skid device adapted to being mounted on tyres of the vehicle wheels to provide traction and wheel to ground contact enhancement in snowy and icy conditions. The device includes a central housing (2) from which protrudes radially three arms (3) which are extended at the outer end by anti-slip components (10) transversally embracing the tread of the tyre. The anti-skid device has a locking mechanism that consists of a locking element (24) with teeth engaging with teeth on the inner circumference of the housing (2). A handle 16 integrated into the hub (4) interfaces with the locking element (24) to securely maintain the locked status when the device is mounted onto the wheel.

### TECHNICAL FIELD

This invention relates generally to an anti-skid device for use in connection with vehicle wheels to improve traction in snow and ice. In particular, it relates to an anti-skid device having a plurality of at least three arms comprising anti-slip elements intended to be arranged on the tread surface of the tyre, operating means to allow the extension or contraction of said arms, where said operating means are equipped with locking means preventing extension of arms when the anti-slip elements are engaged.

### BACKGROUND ART

A variety of anti-skid devices are available for mounting on vehicle tyres to enhance friction under extreme snow and ice conditions. Snow chains have been the standard for many years, though effective, they suffer from several disadvantages. Some of the disadvantages with such chains is that they are heavy, cumbersome, noisy in contact with bare pavement or with the inside of the fenders and require jacking-up the car to mount on wheels. A motorist faced with all these difficulties tends to leave the chains mounted even in ice and snow-free roads and this results in an accelerated rate of wear of the chains. In addition, these kinds of devices take up valuable space when not in use. To overcome the limitations of traditional snow chains, other types of anti-skid devices have been invented, these are devices composed of a plurality of arms radiating from a central housing, each arm is linked to a hook-like anti-slip component which extends transversally over the tread of the tyre.

An anti-skid device of the above type is disclosed in NO 20191262. In this there is shown an anti-skid device for enhancing traction on slippery roads having three arms held within a housing and arranged to be extended therefrom where the ends of the arms have anti-slip elements that can be made to fit around a tyre.

This device has locking means to prevent the anti-slip elements from coming loos from the tyre when in use.

However, the locking means are difficult to operate and may come loose. There therefore exist a need for a better way of locking the anti-slip elements when in use.

Other examples of such devices are described in the following patents: (1) GB 2272193, (2) U.S. Pat. No. 4,209,049A, (3) U.S. Pat. No. 4,834,158A, (4) U.S. Pat. No. 2,873,783A, (5) U.S. Pat. No. 4,735,248A, (6) U.S. Pat. No. 6,053,227, (7) EP0110838 and (8) KR 20040091223. Although these anti-skid devices fulfil their intended purposes, they suffer from several shortcomings, they are complex, cumbersome, made of many parts, expensive to manufacture, difficult to place upon the wheel, heavy, and take up space when not in use. In general, they lack simplicity. It is therefore an object of the present invention to overcome many of the disadvantages of the prior art and to present to the market an anti-skid device that is simple, effective and efficient, compact, lightweight and cheap to manufacture.

The invention may also contribute to less formation of floating dust. This kind of dust is of particular concern with the standard studded tyres used in the winter, as the invention will encourage drivers to opt for non-studded tires instead, using the invention to help overcoming adverse icy conditions.

### SUMMARY OF INVENTION

The primary object of this invention is to provide an anti-skid device which is easy to mount and dismount from the wheel without the need of skills, physical strength or a separate tool.

Another object of the invention is to provide an anti-skid device which is simple, compact and made of few parts.

Another object of this invention is to provide an anti-skid device which can be mounted from the front face of the wheel and can be adapted to different wheel sizes.

Another object of this invention is to provide an anti-skid device which remains fastened even if the wheel changes diameter due to the flattening of the tyre at the wheel-ground contact.

These and other objectives are achieved by providing the device with locking elements that keeps the device fastened to the wheel during use.

### BRIEF DESCRIPTION OF DRAWINGS

FIG. 1 is a front view of the anti-skid device,

FIG. 2 is an exploded view of the device with the wheel grips removed. FIG. 2b shows an alternative embodiment of locking element.

FIG. 3 is a front view of the anti-skid device with the handle opened.

FIG. 4 is a vertical section of the hub with the handle opened.

FIG. 5 is a vertical section of the hub with the handle closed,

FIG. 6 is a detail of FIG. 5,

FIG. 7 shows a first embodiment of a wheel grip,

FIG. 8 shows a second embodiment of a wheel grip, and

FIG. 9 is a side view of FIG. 8 with a cover component removed for clarity.

FIGS. 10-11 show an embodiment with spring loaded button.

FIGS. 12-15 show embodiments of additional anti-slip elements

### DESCRIPTION OF EMBODIMENTS

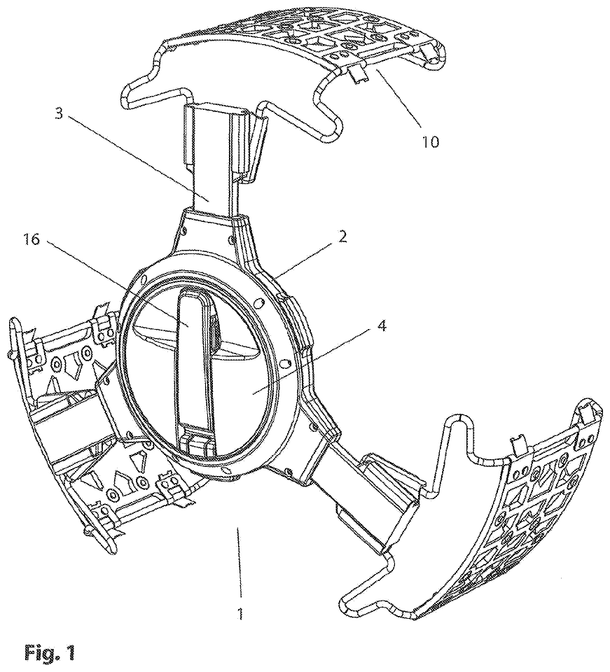

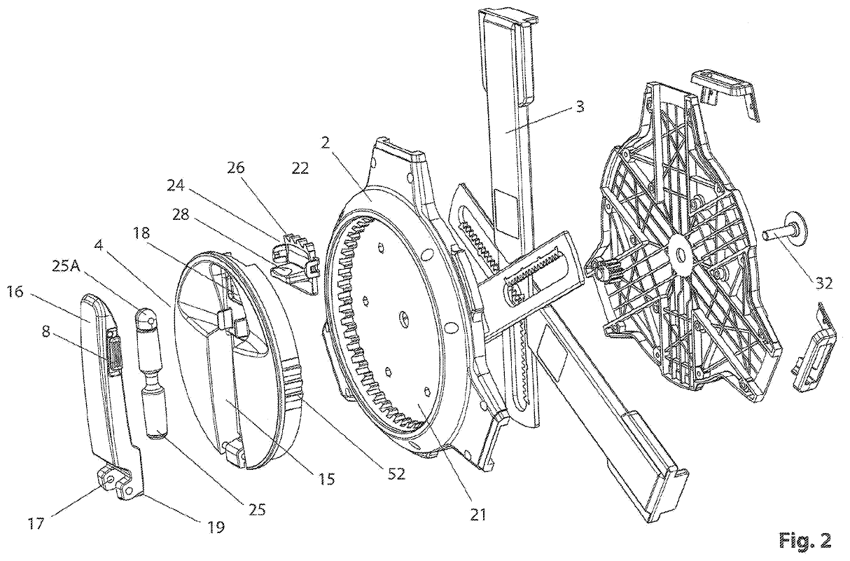

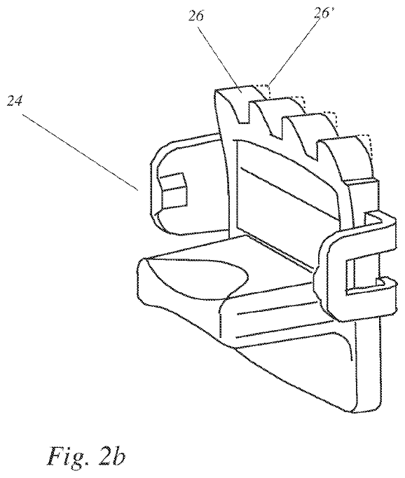

Referring to FIG. 1 there is shown an anti-skid device 1 according to the invention. The device 1 consists of a housing 2 and three arms 3. Although three arms are shown in the drawings it should be understood that there may be four or more arms. The housing encloses the inner ends the arms 3 and the mechanism for operating the arms. A hub 4 is rotatable in the housing 2. The hub has a shaft 32 (see FIG. 2) that is connected to a pinion that in turn enables the arms to move outwards resp. inwards. These details are more fully described in our previous application No. 20191262 and will not be further discussed here since they do not form a part of the present invention.

At the outer end of each arm 3 there are anti-slip elements 10 (see FIGS. 1, 7-9).

Referring now to FIG. 2 the hub has a recess 15. A handle 16 has at one end a hinge 17 enabling the handle to be folded into the recess 15. There is also an opening 18 through the hub. At the other (distal) end of the handle there are means that interfaces with a locking mechanism. This will be described in more detail later.

The handle is folded into the recess when in its locked position. It is also folded when not in use, for example during transport. The handle may include a release element 8 with a catch that can be operated in order to swing the handle outwards. This is an additional safety feature to avoid accidental folding out of the handle 16.

A crank 25, located within the handle when not in use, can be swung outwards and is used to rotate the hub 3 and via the axle 32 used to operate the inwards or outwards movement of the arms 3. The crank 25 is hinged to the handle 16 on a pivoting base 25A that interface with the locking mechanism as described further below.

The housing 3 has a circular recess 21 accommodating the hub 4. The housing has an inner diameter that is slightly larger than the outer diameter of the hub 4 enabling the hub 4 to rotate in the housing 2 on the axle 32. The inner circumference of the housing 3 is equipped with multiple protrusions or teeth 22.

A locking element 24 is held below and protrudes through the recess 18 in the hub 4. Locking element 24 is equipped with a number of protrusions or teeth 26 along a peripheral edge that can interface with corresponding teeth 22 in the housing 2. On the side 27 facing towards the user a rib 28 protrudes outwards and divides the facing side 27 into upper and lower areas. Whilst locking element 24 is positioned between hub 4 and housing 2, the rib 28 penetrates window 18 and is thus accessible to the user. Rib 28 thus acts as a sliding lever that allows the user to manually move the locking element 24 into or out of contact with the ring teeth 22. With reference to FIGS. 2 and 2b, the locking element 24 teeth 26 may be sloped so to more easily interlock with corresponding teeth 22 in the housing. Numeral 26′ in FIG. 2b show where the teeth are sloped relative to teeth 26 in exploded FIG. 2.

In addition, the geometry of the interacting components is such that the handle 16 and crank 25 may not be properly closed when the locking element 24 is in the Open position, as the pivoting base 25A of the crank will crash with rib 28 of the Lock while the Lock is in Open position. More clearly, the locking element 24 must be locked in order to be able to close the device such that it is ready for use—an additional safety feature.

When handle 16 is opened outwards the locking element 24 is free to move.

In a preferred embodiment the two areas visible on either side or rib 28 are colour coded so that the operator can determine the state of the locking element. For example, green for the side closest the centre of the hub and red for the side away from the centre. When the locking element is in either the locked or open positions, only one of these colours will visible, thus clearly indicating the status of the device.

FIG. 3 shows a front view of the device in the operating position. The handle 16 has been folded out from the recess 15. The crank 25 is at its end 25A hinged to the handle and when swung out, as shown in FIG. 3 is used to turn the hub which in turn operates the arms. FIG. 3 shows the locking element 24 engaged with the teeth 22 in the housing with the rib 28 protruding through the window 18, i.e. in locked position. Prior to operation of the handle the locking element 24 is disengaged, thus enabling the hub to be turned.

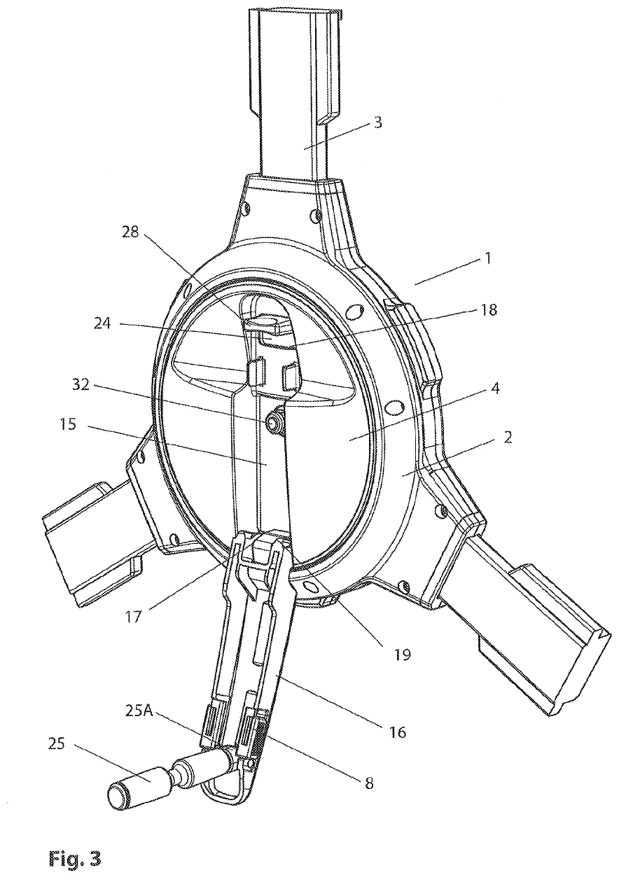

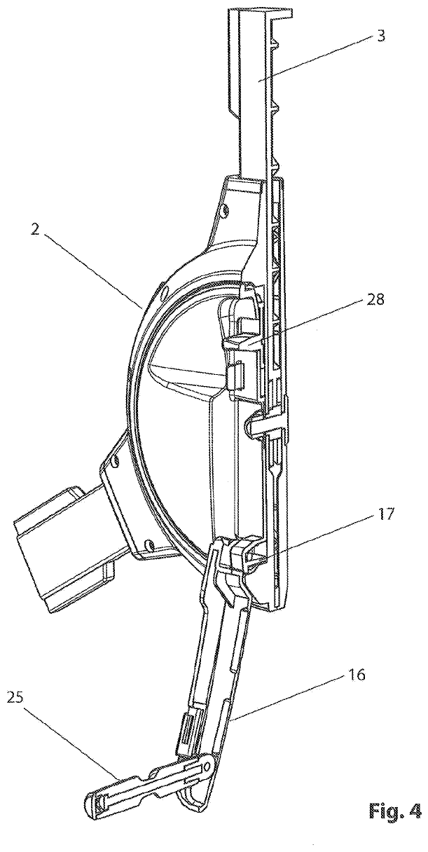

FIG. 4 is a side view of the hub and housing shown in FIG. 3. As can be seen, the locking element 24 has now been pushed out of engagement with the housing teeth 22 and rib 28 is at the end of recess 18 nearest the centre of the device.

FIG. 5 is a side view of the hub showing the handle and crank folded back into the recess 15. In this locked position, the handle 25 and pivot 25A fit underneath the rib 28 of the locking element 24. The hub 4 is now secured against rotation.

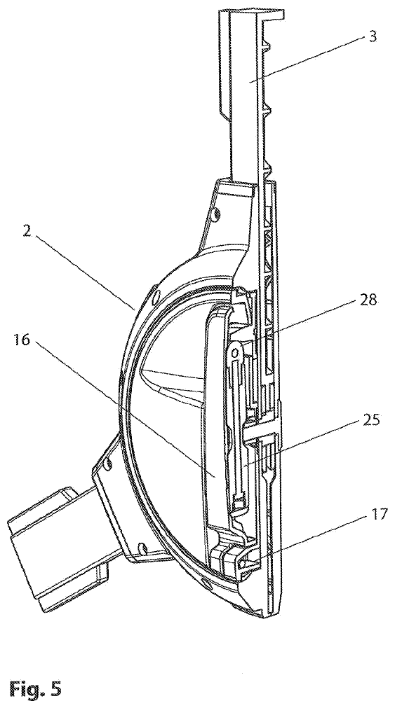

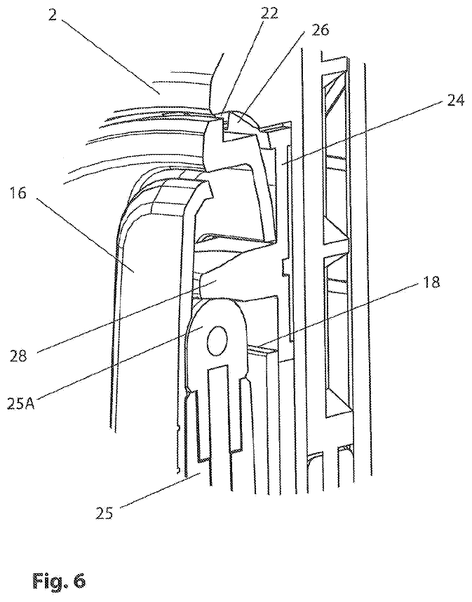

In FIG. 6 there is shown a detail of FIG. 5 showing the method of holding the locking element 24 in a secured position. The rib 28 that protrudes through the window 18 interfaces with end 25A of crank 25. Crank 25 is pushed so that its end 25A is under the rib 28. Then when handle 16 is closed the locking element is held in contact with teeth 22, i.e., its locking position. Buttons 8 secure the handle 16 to the hub 4 so that the handle 16 may not open accidentally while driving.

In addition to the teeth on the Lock, 2 additional teeth 19 are integrated with the lower pivoting end of the handle 16 close to hinge 17. When the handle 16 is moved to the closed position, the teeth will form an additional mechanical lock with the teeth 22 in the housing.

The hub 4 may also be equipped with one or more flexible teeth elements 52 made of an elastomer or a rubber, visible in FIG. 2. These will not overmuch hinder the rotation of the hub 4 but will provide a more positive feel/clicking when the user rotates the handle in order to help match/position the teeth during locking. In addition, these flexible teeth elements 52 may provide a braking function in the event that the entire system is positioned very tightly. i.e. When the user starts to unlock the centre hub 4, an undesired reverse rotation may occur as the arms 3 move immediately outwards. Such an unexpected movement may startle the user, and the flexible teeth elements 52 may effectively dampen such a movement.

The operation of the device is as follows: When not in use the device is stored in the boot of the car. When it is needed the device will be placed beside the wheel and the handle & crank swung open. Then the crank is used to first turn the hub anti clockwise to extend the arms 3 outwards such that the device can be mounted onto the wheel. When in place around the tyre the crank 25 will be turned in the clockwise direction to retract the arms 3 until the anti-slip elements fit tightly around the rim of the wheel. When the operator is satisfied that the anti-slip elements have fully engaged with the tyre, he or she will move the locking element 24 into engagement with the teeth 22. The locked status may be verified by observing the face of the locking element showing green. Then the user can move the crank back into the handle and handle folds back into the recess. Thus the anti-slip elements are held in place. Upon completion of the journey the same process is utilized in reverse.

The same procedure is used to mount a second device on the other driving wheel. While it is not foreseen that it should be necessary to use the device on all four wheels of a 4-wheel drive car, it may at times be necessary since some 4-wheel drive cars will adjust the power to the driving axle that has the least resistance.

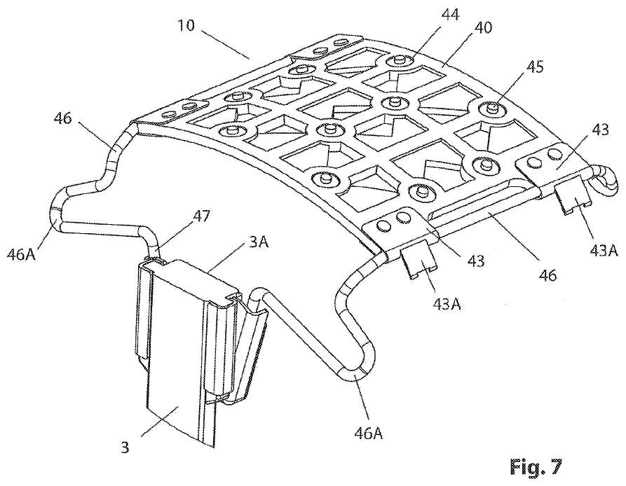

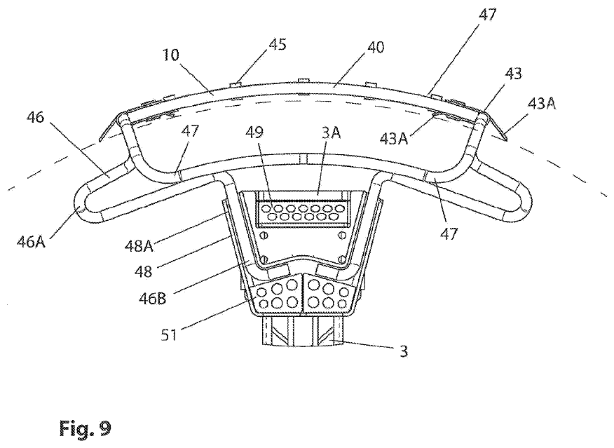

Referring now to FIG. 7, the anti-slip element 10 consists of a pad 40 that is equipped with multiple raised studs 45 irregularly spaced, protruding from both the inner and the outer surfaces to increase friction with the ground, and to prevent any circumferential movement of the anti-slip components along the tyre tread. The friction pads 40 are preferably made in a flexible rubberlike material e.g. TPU Thermoplastic Polyurethane. The pads are held in a steel hoop wire structure 42 by encompassing metal brackets 43 in the corners. The metal brackets advantageously include a forward and backwards facing structure 43A that engages with the rubber tyre when the weight of the car is applied ie. the pads are between tyre and ground. The forwards and backwards facing structures 43A prevent the pads slipping on the tyres (more clearly visible in FIG. 9). The studs 45 are preferably metal, and have a wider area on each side e.g. A washer 44 prevents the stud 45 being pulled out/rotating in an undesirable manner. A wire hoop 46 surrounds the pads and provides a lightweight, resilient pad assembly, preferably made of spring steel, and may be produced economically. The wire hoops 46 should be made of spring steel, from 5 to 8 mm in diameter.

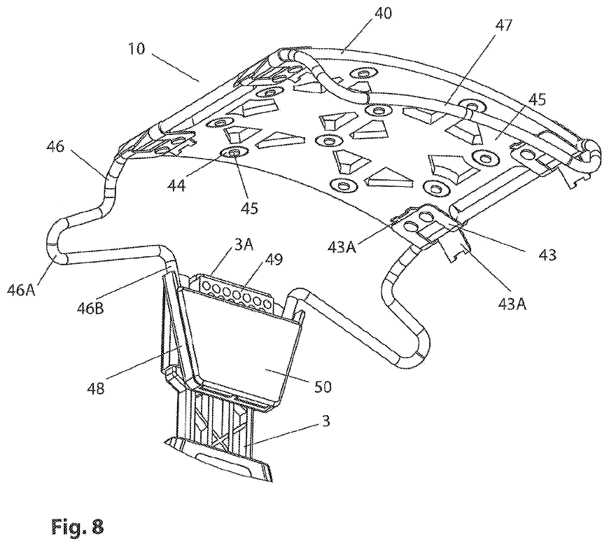

FIG. 8 shows an underside view of the anti-slip element 10. The hook/retention detail 47 (shown in FIG. 8) is formed in the hoop 46 to hold the device 1 into the wheel by gripping on the inner surface of the wheel, thus preventing the device 1 from moving outwards. The shape of the hoop in areas 46A also adds extra spring/flexing performance to absorb some of the forces/deformation caused by the tyre/weight of the car. The wire hoop is completed by a bracket 48 which allows a sliding connection to arms 3. The outward movement of bracket 48 and thus anti-slip element 10 is limited by a protrusion 3A on the ends of arms, thereby providing a secure connection between anti slip elements 10 and arms 3, but allowing the anti-slip elements to be easily disconnected by the user by sliding these inwards towards hub 4. A flexor or spring element 49 is positioned such that it interacts with the underside of protrusion 3A to provide an inwards spring force acting on bracket 48 that maintains contact between the tyre and anti-slip element 10, even in the event that the tyre is locally depressed inwards by for example driving over a rock/kerb. This is more clearly detailed in our earlier application No. 20191262. A pad 50 covers the inner face of bracket 48 thus providing a forgiving surface positioned against the wheel.

FIG. 9 shows a view of the anti-grip element 10 with a partial section through metal bracket 48 to expose the interior. The ends 46B of the wire hoop 46 are retained in two U-shaped channels 48A in metal bracket 48 that is fitted to the end of the arm 3. This allows each wire end 46B to move in and outwards linearly thereby ensuring the anti-slip elements 10 stay close to the tyre surface during driving. The wire ends 46B are shaped so they cannot move up/outwards. In turn they press downwards on spring elements 51 which then return the wires to starting position once the tyre has rotated further. The independent movement of the individual wire ends 46B is an advantage as it means the car first drives over one end of the wire and this movement only affects that end, not trying to rotate the entire anti-slip element 10 as would be the case should the wire not be retained independently.

In this preferred embodiment, studs 45 can take the form of protuberances, but may also take the form of holes or local areas formed from a high friction material. Circumferential movement prevention is further enforced by the curved shape of the anti-slip element 40. An additional benefit of the curved shape is observed under braking conditions, where curved shape will mechanically engage with the deformable rubber of the tyre, thus not relying solely upon the friction created by the grip details. This is important in that it reduces the forces exerted upon arms 3 and housing 2 during braking. Undesired outwards movement of the anti-slip element 40 relative to the tyre is prevented by a return detail 47, cupping the inside wall of the tyre and preventing the device 1 from loosening from the tyre. This is particularly relevant in the case where a wheel spinning at higher speed while turning the car to the left or right may exert a combination of centrifugal and axial outwards forces on the device 1, requiring an extremely secure fastening of device 1 to the tyre. In alternate embodiments, return detail 47 may be replaced by one or more hook details, or a hinged flange detail able to be locked in a downwards position thus preventing outwards movement of anti-slip element 10. Anti-slip element 10 could also be formed in other ways to perform the same task without deviating from the spirit of the invention.

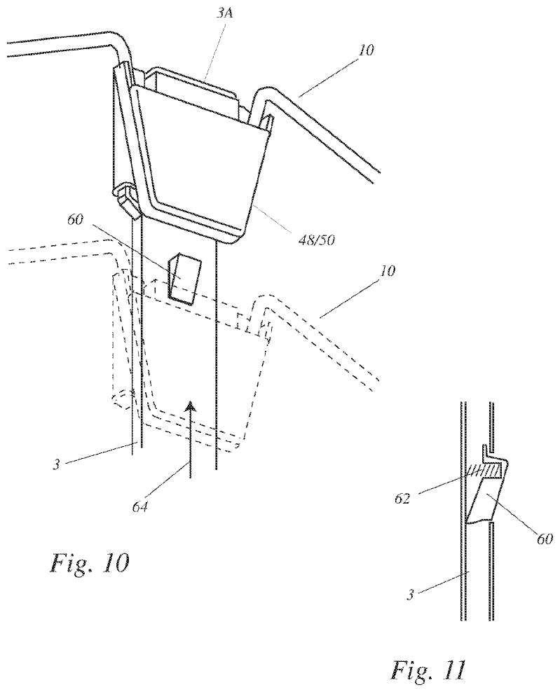

Anti-slip elements 10 are removably connect to arms 3, whereby bracket 4 allows a sliding connection, limited at one end by the projection 3A at the distal end of arm 3. When connecting the anti-slip elements 10 to the arms 3 they are free to slide along the length of the arms until end section 3a. When assembling device 1 to the wheel, it is an advantage that the sliding connection between elements 10 and arms 3 is limited such that the elements remain situated at the distal end of arms 3. As disclosed in FIGS. 10 and 11 a spring 62 loaded button 60 is present on the inside of the arms 3, arranged at a predetermined distance from projection 3A. This prevents the anti-slip elements from sliding inwards towards the hub during assembly, when slid past the button 60, illustrated by arrow 64. Advantageously the button may be shaped such that it is automatically depressed as the user slides bracket 48 towards projection 3A along arm 3. The button 60 then provides a stop detail once bracket 48 has moved past button 60. When removing the anti-skid device 1 from wheel and dismantling the anti-slid elements 10 from arms 3, the button must be pressed inwards to allow the anti-slide elements 10 to pass the button along the arms 3 for removal and storage.

When the anti-skid device 1 is fixed on to the wheel of a vehicle, the area between the anti-slip elements 10 provide only of the original tyre surface for grip on the surface. When the wheel is spinning it will lose grip between the anti-slip elements 10. This could be a problem especially when braking to stop if only the tyres are in contact with the slippery surface. Therefore, the invention includes additional anti-slip elements of which can be connected between the elements 10 when the anti-skid device is fixed on to the wheel. A further advantage provided by the connection of the additional anti-slip elements is that the forces applied to a single arm 3 when braking is now distributed over the elements surrounding the tyre surface.

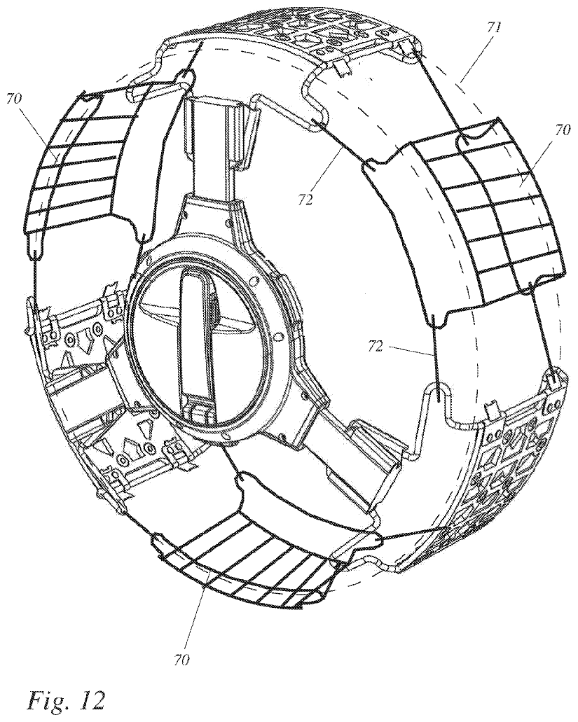

FIG. 12 show the anti-skid device 1 fixed on to a wheel and tyre 71. The added anti-slip elements 70 are similar to the elements 10 with pads 40 and studs 45. The fixatures 72 are used to connect the elements 70 to the adjacent anti-slip elements 10. The fixtures 72 may be of metal hooks, wire and spring elements for tightening, similar to those used on traditional snow chains. Preferably the fixtures 72 should allow for tightening with for example an adjustable over-centre mechanism creating a secure connection between elements 70 and 10 on either side.

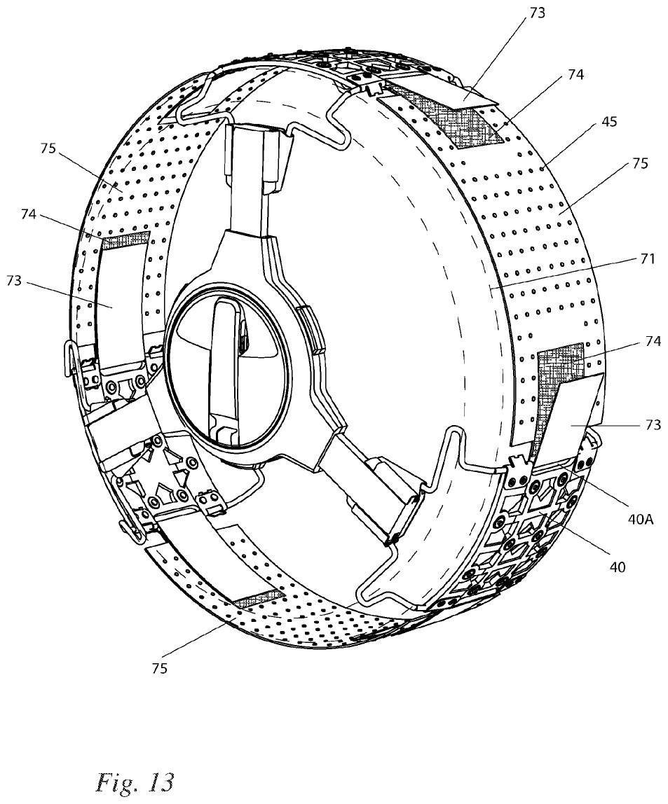

FIG. 13 illustrates another embodiment of extra anti-slip elements 75 herein in the form of mats covering only the exposed contact surface of the tyre 71, also equipped with studs 45 similar to those used on anti-slip elements 10. The mats 75 may be made of one of several materials, for example a heavy duty textile equipped with metal studs. In the preferred embodiment illustrated in FIG. 13, Mat 75 may also be moulded in a flexible, rubberlike material, for example a TPU or thermoplastic polyurethane, whereby studs 45 may if desired be moulded onto the inner and outer surface of mat 75 to improve grip, negating the need for the insertion of many individual metal studs.

The anti-slip elements 70, 75 will have adjustable fastening means 73, 74 in order to adjust according to different wheel sizes, and to fasten securely to surrounding anti-slip elements 10. The said elements 70, 75 may alternatively be provided in different sizes/lengths according to wheel dimensions. Fastening means 73, 74 should preferably be as flat as possible so as not to affect the anti-slip properties of mat 75. In this preferred embodiment, fastening means 73, 74 comprises a hook and loop connection, whereby a pad 74 with either hook or loop material, in this embodiment hook material, permanently affixed by mechanical or chemical means to each end of mat 75. In this embodiment, fastening means 73 comprises a flexible component equipped on its inner surface with hook or loop material, in this embodiment hook material, arranged to engage with the material 74 on pad 75. An advantage of this system is that the hook and loop fastening means allows the user to attach elements 75 to elements 10 after the device 1 is loosely attached to the tyre 71, and thereafter to tighten the fastening means 73 once device 1 is in turn tightened and securely attached. An additional advantage is that when the weight of the vehicle is applied to the fastening means 73, 74 as they pass between the wheel 71 and the road surfaces, said fastening means will be more tightly and securely pressed together. Should the thickness of fastening means 73, 74 be greater than desired, it is possible to locally increase the thickness of mat 75 such that the outer portions of mat 75 are thicker than the area where fastening means 73 is arranged, thereby allowing for a more homogenous assembled thickness. In the embodiment shown, mat 75 is equipped with pads 74 on both inner and outer surface to allow for the greatest possible adjustment. Fastening means 73 may also be permanently attached at one or both ends of mats 75, whereby the loose end of the fastening means is folded back upon itself such that the hook or loop material on its inner surface engages with the matching material on pads 74.

Now in the preferred embodiment illustrated here, it will be obvious that fastening means 73 wraps around a section of wire hoop 46, thereby connecting element 75 to anti slip element 10. In this embodiment, the friction pad 40 of anti-slip element 10 is equipped with a recess 40A, allowing an area for threading fastening means 72 through pad 40 and around wire hoop 46. While mat 75 is equipped with a single example of fastening means 73, 74 at each end, it should be noted that mat 75 could be equipped with multiple fastening means 73, 74 at each end if this proved desirable. In another preferred embodiment, fastening means may also be in the form of one or multiple chain segments attached to the ends of mat 75, where the chain segments are in turn equipped with a hook or locking detail for attachment to anti-slip elements 10.

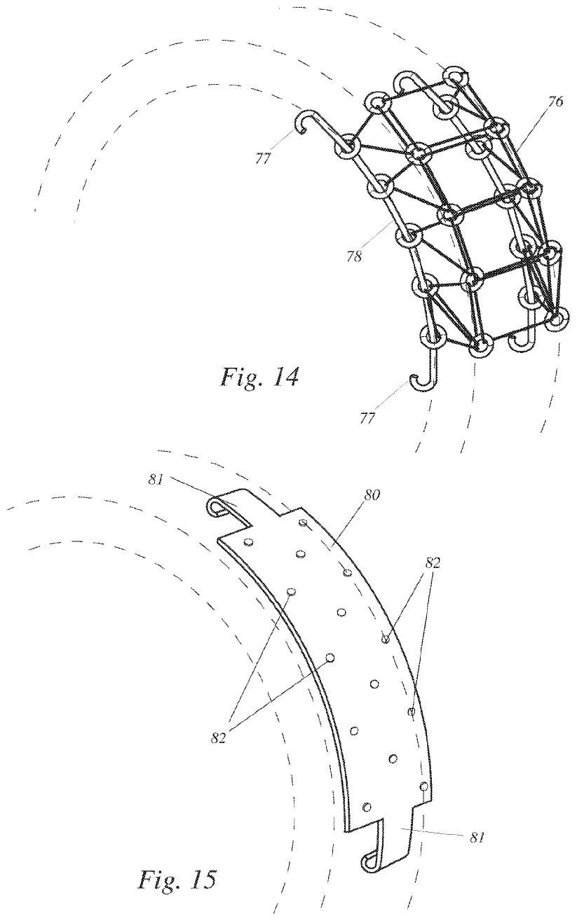

FIGS. 14 and 15 disclose in more detail embodiments of additional anti-slip elements, denoted 76 and 80, which can be fixed to and between the anti-slip elements 10. Anti-slip element 76 represent a type chain of which is connected to the outer parts of wire hoops 46, by means of hooks 77 of which are interconnected by a flexible cable 78, or partial springs and wire. Anti-slip element 80 comprises of a pad of which only covers the contact surface of a tyre. It is made to be fixed to and between the anti-slip elements 10 at centre of width by hooks 81. The whole pad 80 is made of a flexible material such as rubber, with a number of studs 82. The hooks 77 and 81 will include a locking mechanism to prevent accidental release, for example of carabiner type, this however is not shown in the figures.

1-15. (canceled)

16. A traction and anti-skid device for limited and emergency use on wheel tires for easy assembly use and storage, the said device comprising of a main body and housing with protruding arms and detachable anti-slip elements, wherein;
a plurality of at least three arms is held within a main housing and protruding radially therefrom with means for attaching anti-slip elements,
a hub rotatable within the housing, rotatable by a handle whereas to allow the extension or contraction of said arms,
operating means equipped with locking means preventing extension of arms when anti-slip elements are engaged on the tread surface of the tire,
there are locking means of the movement of the arms which comprise of a locking element located between the hub and the housing the locking element being operable into a position where teeth engage with a second set of teeth located along the inner periphery of the housing, and whereas the arms, have a means for limiting the travel of anti-slip elements along the length of the arms during assembly and attachment of anti-slip elements, and wherein anti-slip elements are prepared for additional anti-slip elements to be fixed to and between main anti-slip elements.

17. The anti-skid device according to claim 15, wherein said locking element is movable between a first position where the teeth engage the housing teeth and a second position out of contact with the teeth.

18. The anti-skid device according to claim 17, wherein the teeth of locking element are sloped so to more easily interlock with corresponding teeth in the housing.

19. The anti-skid device according to claim 17, wherein the locking element includes a rib protruding through a window in the hub whereas the hub is rotated using a hinged handle and a crank, said hinge including teeth arranged to interface with the teeth in the housing.

20. The anti-skid device according to claim 19, wherein the handle can be folded into a recess in the hub.

21. The anti-skid device according to claim 16, wherein said anti-slip element is equipped on its inner and outer surfaces with multiple studs irregularly spaced.

22. The anti-skid device according to claim 16, wherein said anti-slip element is held in a wire hoop with ends that fits into a bracket removably connected at the end of the arm making anti-slip elements detachable from arms for compact storage.

23. The anti-skid device according to claim 16, wherein the arms, have a spring loaded stop and release button for limiting the travel of anti-slip elements along the length of the arms.

24. The anti-skid device according to claim 16, wherein additional anti-slip elements are available and have means to be fixed to and between main anti-slip elements.

25. The anti-skid device according to claim 16, wherein additional anti-slip elements are provided in different sizes to fit a variety of wheel sizes.

26. The anti-skid device according to claim 16, wherein additional anti-slip elements are made of heavy duty textile or flexible rubber like material, equipped with metal studs.

27. The anti-skid device according to claim 16, wherein additional anti-slip elements are made of a flexible string, wire, chain and or wire mesh.

28. The anti-skid device according to claim 16, wherein additional anti-slip elements have adjustable means for fastening to anti-slip elements.

29. The anti-skid device according to claim 28, wherein adjustable means comprise of a hook and loop material.

30. The anti-skid device according to claim 28, wherein adjustable means comprise of hooks attached with flexible means.
